(19) United States
(12) Patent Application Publication
(10) Pub. No.: US 2022/0397411 A1
(43) Pub. Date: Dec. 15, 2022

(54) SYSTEMS AND METHODS FOR DELIVERING CONTENT TO A USER BASED ON GEOLOCATION

(71) Applicants: Quinn Brown, Nashville, TN (US); Greg Page, Nashville, TN (US); Daniel Page, Nashville, TN (US)

(72) Inventors: Quinn Brown, Nashville, TN (US); Greg Page, Nashville, TN (US); Daniel Page, Nashville, TN (US)

(21) Appl. No.: 17/806,227

(22) Filed: Jun. 9, 2022

Related U.S. Application Data
(60) Provisional application No. 63/202,398, filed on Jun. 9, 2021.

(51) Int. Cl. G01C 21/36; G01C 21/34

(52) U.S. Cl. CPC G01C 21/3638; G01C 21/3476; G01C 21/3644; G01C 21/3679; G01C 21/3629

(57) ABSTRACT

A system for delivering content to a user based on geolocation may include a user device with a location sensor and a software application. The system may include a server, including executable instructions configured to execute a tour module. The server may include a data storage, including user data and tour data stored thereon. The tour data may include a point of interest (POI) data object, including location data and content data. The software application may be configured to obtain a location of the user device from the location sensor and send the location to the tour module. The tour module may be configured to determine, from the location of the user device, that the user device is within a geo-fence of the POI data object and send the content data to the software application. The software application may be configured to display the content data on the user device.

### CROSS-REFERENCES TO RELATED APPLICATIONS

This application claims priority to U.S. Provisional Patent Application No. 63/202,398, entitled “SYSTEMS AND METHODS FOR DELIVERING CONTENT TO A USER BASED ON GEOLOCATION,” filed on Jun. 9, 2021, and which is incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE DISCLOSURE

With mobile devices, including smart phones and tablets, becoming more common and having more computing power, their enhanced capabilities can be utilized to enrich a user's experience in a variety of ways. One area that has been lacking regarding using mobile devices to enhance a user's experience is the tourism industry. Currently, when a tourist visits a point of interest, the user's mobile device is relegated to simply providing information about the point of interest in a static, un-personalized manner.

What is needed then are systems and methods for delivering content to a user based on geolocation.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to systems, devices, and methods for delivering content to a user based on the user's geolocation. The content may include content of interest to the user and may include historical, musical, or architectural content, or content of some other nature. As an overview, one aspect of the present disclosure may include a mobile user device (herein, a “user device”) and a server in data communication with each other over a data network. The user device may include a software application installed on the user device. The software application may send data to and receive data from the server over the data network. Data received from the server may include geo-fence data of a point of interest. In response to the user device crossing the geo-fence (as determined, for example, by a location sensor of the user device), the user device may display content related to that point of interest. The content may include an image, a video, audio, virtual reality (VR) content, augmented reality (AR) content, or other types of content. The user device may receive the content from the server.

In another aspect of the present disclosure, the software application of the mobile device may include spatial audio content. Spatial audio content may include audio content where different audio sources change volume based on a location of the user device. Audio content may include musical content, vocal content, or other audio content. For example, spatial audio content may include a virtual guitar, a virtual drum set, and a virtual vocalist. Each virtual instrument may include an audio track, and the audio tracks may be synchronized. When the user device moves (as determined by a location sensor or other movement sensor of the device) toward the virtual guitar, the audio track corresponding to the guitar may play louder, and the other audio tracks may play softer. When the user device moves toward the virtual drum set, the audio track corresponding to the drums may play louder, and the other audio tracks may play softer. The user may move the user device to different locations to hear different volumes of the different audio tracks until, for example, the user finds a location where the volume balances are most enjoyable to the user.

Numerous other objects, advantages and features of the present disclosure will be readily apparent to those of skill in the art upon a review of the following drawings and description of various embodiments.

### BRIEF DESCRIPTION OF THE DRAWINGS

FIG. 1 is a block diagram illustrating one embodiment of a system for delivering content to a user based on geolocation.

FIG. 2 is a schematic block diagram illustrating one embodiment of a user device for a system for delivering content to a user based on geolocation.

FIG. 3 is a schematic block diagram illustrating one embodiment of a server for a system for delivering content to a user based on geolocation.

FIG. 4 is a front view of a user interface of a software application of a system for delivering content to a user based on geolocation.

FIG. 5 is a front view of another user interface of a software application of a system for delivering content to a user based on geolocation.

FIG. 6A is a front view of another user interface of a software application of a system for delivering content to a user based on geolocation.

FIG. 6B is a front view of another user interface of a software application of a system for delivering content to a user based on geolocation.

FIG. 7 is a front view of another user interface of a software application of a system for delivering content to a user based on geolocation.

FIG. 8A is a front view of another user interface of a software application of a system for delivering content to a user based on geolocation.

FIG. 8B is a front view of another user interface of a software application of a system for delivering content to a user based on geolocation.

FIG. 9 is a front view of another user interface of a software application of a system for delivering content to a user based on geolocation.

FIG. 10 is a front view of another user interface of a software application of a system for delivering content to a user based on geolocation.

FIG. 11A is a front view of a user interface for a spatial audio experience of a software application of a system for delivering content to a user based on geolocation.

FIG. 11B is a front view of another user interface for a spatial audio experience of a software application of a system for delivering content to a user based on geolocation.

FIG. 11C is a front view of another user interface for a spatial audio experience of a software application of a system for delivering content to a user based on geolocation.

FIG. 11D is a front view of another user interface for a spatial audio experience of a software application of a system for delivering content to a user based on geolocation.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

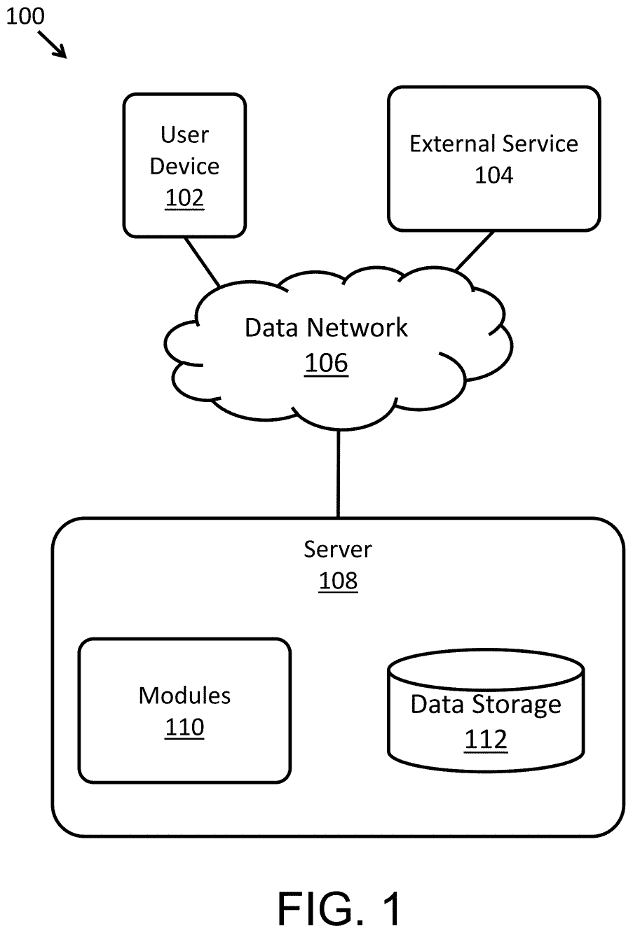

Further details of embodiments of the present disclosure are now discussed. FIG. 1 depicts a system 100. The system 100 may include a system for delivering content to a user based on geolocation. The system 100 may include a user device 102. The system 100 may include an external service 104. The system 100 may include a data network 106. The system 100 may include a server 108. The server 108 may include one or more modules 110 or a data storage 112.

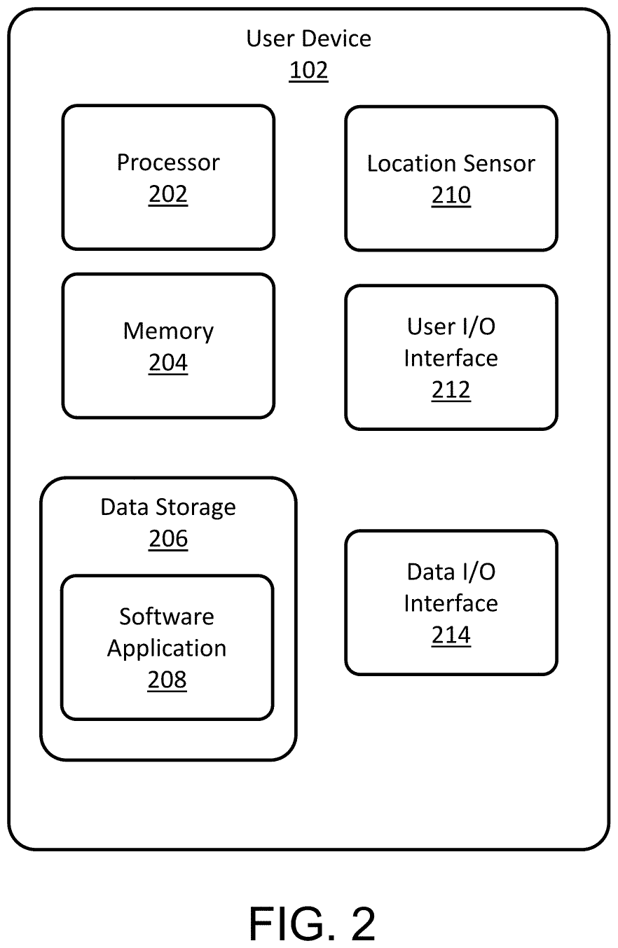

FIG. 2 depicts one embodiment of a user device 102. A user device 102 may include a computing device. A computing device may include a smart phone, a smart watch, a tablet computer, a laptop computer, a desktop computer, a gaming console, an application server, a database server, or some other type of computing device. The user device 102 may include a processor 202. The processor 202 may include a central processing unit (CPU), graphics processing unit (GPU), a processor core, a multi-core processor, or some other processor. The user device 102 may include a memory 204. The memory 204 may include volatile memory such as random access memory (RAM) (either static (SRAM) or dynamic (DRAM)). The memory 204 may store data, software applications, or other information that can be accessed and processed by the processor 202.

The user device 102 may include a data storage 206. The data storage 206 may include non-volatile memory or non-volatile data storage. For example, the data storage 206 may include read-only memory (ROM), flash memory, a hard disk drive (HDD), optical disk drive, or other data storage. In some embodiments, the data storage 206 may include a software application 208. The software application 208 may include an application in data communication with the server 108 that may deliver content to the user of the user device 102 based on the user's geolocation. The software application 208 may include a web browser, a mobile application, a software application installed on the user device 102, or some other type of software application.

The user device 102 may include a location sensor 210. The location sensor 210 may include a geolocation sensor. The geolocation sensor may include a global positioning system (GPS) sensor that receives data from one or more GPS satellites and determines the user device 102 location based on the satellite data. The geolocation sensor may include a cellular sensor that receives data from a cellular network and determines the user device 102 location based on the cellular data. The geolocation sensor may determine the location of the user device 102 using other types of data or geolocation means. In some embodiments, the location sensor 210 may include an accelerometer, a gyroscope, a motion sensor, or some other type of location sensor. The location sensor 210 may allow the user device 102, the software application 208, or the server 108 to obtain a longitude, a latitude, an altitude, an orientation, or other location data regarding the user device 102.

The user device 102 may include a user input/output (I/O) interface 212. The user I/O interface 212 may include hardware or software of the user device 102 that receives user input from the user and transmits output on the user device 102 for the user to perceive. The user I/O interface 212 may include, as an input device, a mouse, a keyboard, a touchscreen, a microphone, a camera, one or more buttons, or other user input devices. The user I/O interface 212 may include, as an output device, a display (including a screen, touchscreen, or other type of video display), an audio speaker, a vibration device, or some other type of user output device.

In some embodiments, the user device 102 may include a data I/O interface 214. The data I/O interface 214 may include software or hardware of the user device 102 configured to send data to or receive data from a device external to the user device 102. The data I/O interface 214 may include one or more wireless transceivers. For example, a wireless transceiver may include a Wi-Fi transceiver, a near-field communication (NFC) transceiver, a Bluetooth transceiver, a cellular network transceiver, or some other type of wireless transceiver. The data I/O interface 214 may include a wired port of the user device 102. For example, a wired port may include a universal serial bus (USB) port, an Ethernet port, a FireWire port, a display or audio port (e.g., video graphics array (VGA), high-definition multimedia interface (HDMI), an audio jack, etc.), or some other type of wired port.

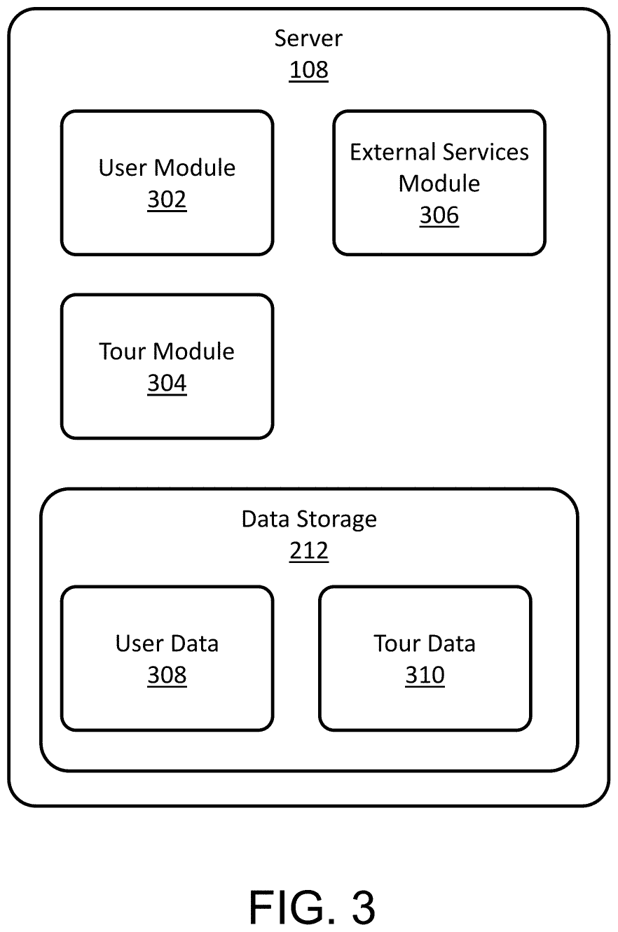

FIG. 3 depicts one embodiment of the server 108. The server 108 may include one or more computing devices, each with their own processor(s), memory, data storage, etc. The server 108 may include one or more modules. A module may include hardware or software that carries out certain functionality on the server 108. The one or more modules may include a user module 302, a tour module 304, or an external services module 306. The server 108 may include the data storage 212. The data storage 212 may include a file system, database, distributed ledger, or other storage system that may be configured to store data. In some embodiments, the data storage 212 may include user data 308. The data storage 212 may include tour data 310. The data storage 212 may include other types of data.

In some embodiments, the server 108 may include a user module 302. The user module 302 may be configured to process, track, or maintain data regarding a user of the system 100, which may include the user of the user device 102. The user module 302 may store this data regarding a user in the user data 308 of the data storage 212. In some embodiments, the user data 308 may include a user profile. The user profile may include information about the user. The information may include a name, age, contact information (e.g., phone number, email address, physical address, etc.), payment information (e.g., bank card information, bank account information, mobile payment platform information, etc.), social networking information (e.g., a social network username or profile, etc.), or other user information. The user data 308 may include a user-generated tour or a badge, which will be discussed below. The user module 302 may receive data from the user device 102 (including data from the software application 208). The user module 302 may process the data or send the data to another module of the server 108 for analysis. The user module 302 may store the received data as user data 308.

The tour module 304 may be configured to process, track, or maintain data regarding points of interest (POIs), tours, content related to a POI or a tour, AR content, spatial audio content, or other data. In some embodiments, the tour module 304 may receive data from the software application 208 of the user device 102, and, in response, may process the received data, determine which tour data 310 to deliver to the software application 208, and send the selected tour data 310 to the software application 208.

In some embodiments, the data exchanged between the user device 102 and the server 108 may include a JavaScript object notation (JSON) object. In some embodiments, the software application 208 or the server 108 may include a representational state transfer (REST) data interface. The RESTful data interface may accept JSON objects and route the data contained within to the appropriate module or other software for processing.

In one embodiment, the server 108 may include an external services module 306. The external services module 306 may send data to or receive data from one or more external services 104 over the data network 106. In one embodiment, an external service 104 may include an advertisement service. The advertisement service may provide advertisement data for the user device 102 to display on the software application 208. In one embodiment, the external services module 306 may send data identifying the user of the user device 102 to the advertisement service, and the advertisement service may send personalized advertisement data to the server 108, and the personalized advertisement data may include an advertisement personalized to the user of the user device 102. The personalization may be based on data sent from the server 108 to the advertisement service, data in a profile that the advertisement service has on the user, or based on other data.

An external service 104 may include an affiliation service. The affiliation service may send an affiliate link to the server 108, and the server 108 may send that affiliate link to the software application 208 of the user device 102 for display to the user. In response to the user of the user device 102 interacting with the affiliate link, the affiliate service may be notified and may calculate a commission to the server 108.

In one embodiment, an external service 104 may include a data analytics service. The data analytics service may include an artificial intelligence (AI) model, a machine learning model, or some other data analytics model. The data analytics service may use the model to process data sent to the data analytics service by the server 108. For example, the data analytics service may receive image data and analyze the image to determine the contents of the image. The data analytics service may search for images or videos containing certain data. The data analytics service may analyze tour data 310 or user data 308.

In one embodiment, an external service 104 may include an in-app purchase service. The in-app purchase service may allow a user of the software application 208 to make in-app purchases. An external service 104 may include a direct payment system. The direct payment system may be configured to accept payment from the user.

An external service 104 may include a music service. The music service may include an online music store or a music streaming service. The server 108 or the user device 102 may send the user's music preferences or other data to the music service. The music service may send the server 108 or the user device 102 a music playlist, audio data, or other data. An external service 104 may include a social networking service. The social networking service may include a social networking profile of the user, which may include information about the user's connections or friends on the social network. The user device 102 may send data to the social networking service in order for the software application 208 to create a post on the social network. The user device 102 may send location data to the social networking service, and the social networking service may send the software application 208 localized content from the social network based on the location.

In one embodiment, the tour data 310 may include a point of interest (POI) data object. The POI data object may correspond to a real-word location that may be of interest to the user of a user device 102 (hereinafter referred to as a “POI”). In one embodiment, the POI data object may include a name. The name may include a string of text that may identify the corresponding POI. The POI data object may include a description. The description may include text data that may describe the corresponding POI. The POI data object may include location data. The location data may include one or more coordinates (e.g., a latitude, a longitude, GPS coordinates, an altitude), geo-fence data, or other location data. The location data may provide information about the location of the corresponding POI.

In some embodiments, the POI data object may include one or more tags. A tag may associate the POI data object with information related to the corresponding POI. For example, in an embodiment where the system 100 relates to musical content, a POI data object may include one or more tags for one or more genres of music associated with the corresponding POI, one or more tags for one or more musical artists associated with the corresponding POI, one or more tags for one or more concerts associated with the corresponding POI, or one or more tags for other types of information.

In one or more embodiments, the POI data object may include content associated with the corresponding POI. The content may include image data, video data, audio data, text data, AR data, VR data, or other types of data associated with the corresponding POI. For example, in an embodiment where the system 100 relates to musical content, the content of a POI data object may include images of the corresponding POI, videos filmed at the corresponding POI (e.g., a video of a concert, video of an interview with a musical artist, etc.), audio recorded at the corresponding POI (e.g., audio from a concert that occurred at the POI), text data describing information related to corresponding POI, AR or VR data (e.g., a virtual tour of the corresponding POI), or other content.

In one embodiment, the tour data 310 may include a tour data object. A tour data object may include one or more POI data objects that may be related based on one or more criteria. In some embodiments, a tour data object may include one or more POI data objects that may include identical tags. For example, in an embodiment where the system 100 relates to musical content, a tour data object may include one or more POI data objects where each POI data object includes a tag corresponding to the musical artist “Johnny Cash.” In some embodiments, a tour data object may include one or more POI data objects that may include location data corresponding to the same location. For example, a tour data object may include one or more POI data objects where each POI data object includes a location located in the city of Memphis, Tenn. In another example, another tour data object may include one or more POI data objects where each POI data object includes a location in the city of Atlanta, Ga. and includes a tag corresponding to the musical genre of “Hip Hop.” A tour data object may include data indicating a name, a description, content (which may include content included with one or more of the POI data objects included in the tour data object), or other data.

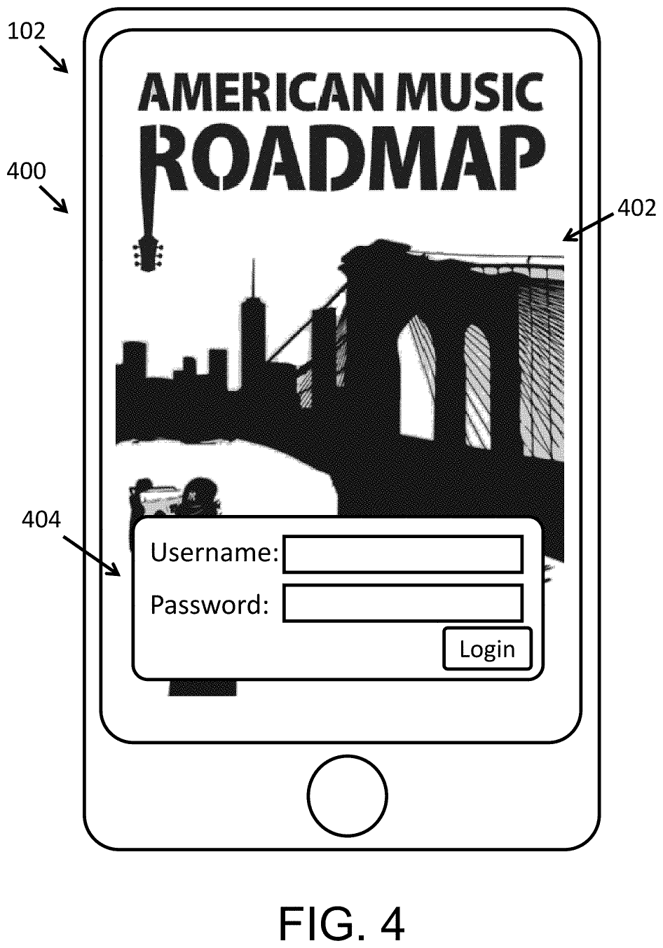

FIG. 4 depicts one embodiment of the user device 102. The user device 102, as depicted in FIG. 4, may execute the software application 208. In response to executing the software application 208, the user device 102 may display a user interface 400 on the display of the user I/O interface 212. The user interface 400 may include a login screen. The user interface 400 may include a background graphic 402. The software application 208 may select the background graphic 402 from multiple possible background graphics. The background graphic 402 may be based on a location of the user device 102 (e.g., a graphic depicting a location near the location of the user device 102), a POI data object tag (e.g., a graphic depicting a musical artist or depicting objects associated with musical genre), or based on other information.

The user interface 400 may include a login area 404. The login area 404 may include text boxes for the user of the user device 102 to enter a username, password, or other login information. The software application 208 may send login data based on the entered login information (e.g., the username, a password hash, etc.) to the server 108 over the data network 106, the user module 302 of the server 108 may authenticate the received login data, and the user module 302 may send data to the software application 208 indicating that the user has been authenticated. In some embodiments, the software application 208 or the user device 102 may store authentication data and may authenticate the user's login data locally on the user device 102.

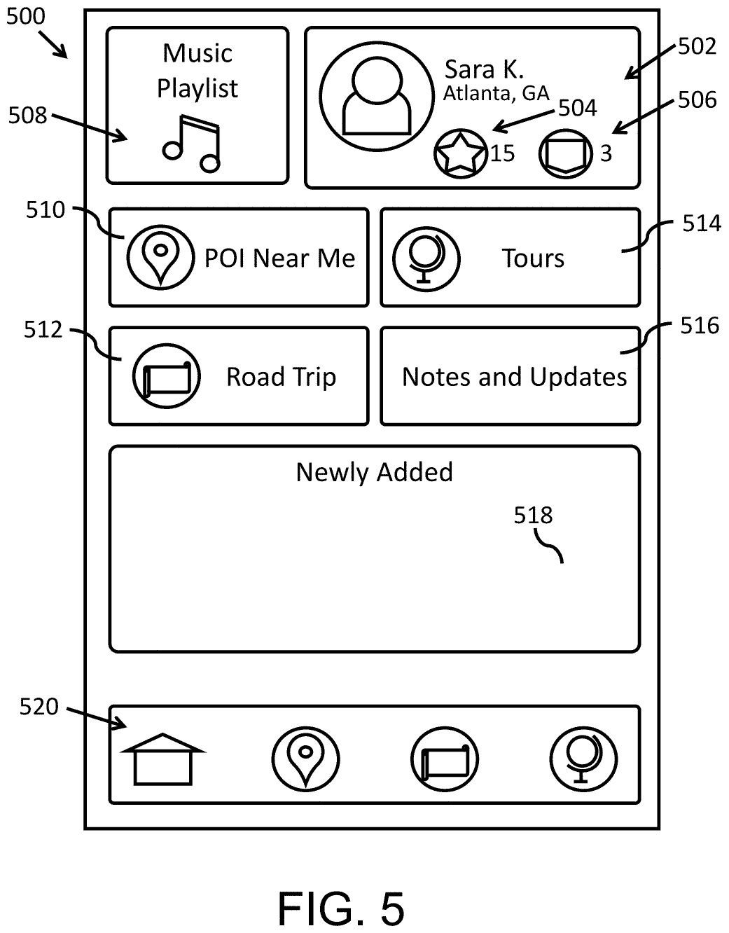

FIG. 5 depicts one embodiment of a user interface 500. The user interface 500 may include a user interface of the software application 208. The software application 208 may display the user interface 500 in response to the user logging into the software application 208 using the user interface 402 of FIG. 4. The user interface 500 may include a “Home” screen of the software application 208.

In one embodiment, the user interface 500 may include a user profile area 502. The user profile area 502 may include a profile picture of the user of the user device 102. The user profile area 502 may include a name of the user. The user profile area 502 may include a location of the user (e.g., the user's city of residence, the user's current location, or some other location). The user profile area 502 may include a number of POIs 504 that the user has visited. The user profile area 502 may include a number of badges 506 that the user has earned. The user may earn badges in response to visiting a predetermined number of POIs, visiting a predetermined POI, visiting all of the POIs included in a tour, or in response to some other user action.

The user interface 500 may include a music playlist area 508. The music playlist area 508 may integrate with a music software application. The music software application may include a music software application installed on the user device 102. The music software application may include a software application configured to play audio on the user device 102. The audio may include audio files located on the user device 102 or may include audio files on an external device that the music software application may stream to the user device 102. The music playlist area 508 may allow the user to play music using the music software application while inside the software application 208. The music playlist area 508 may allow the user to play, pause, skip songs, or other music-listening functionality. The music the music playlist area 508 may play may be based on a music playlist curated by the server 108, the user, or some other entity.

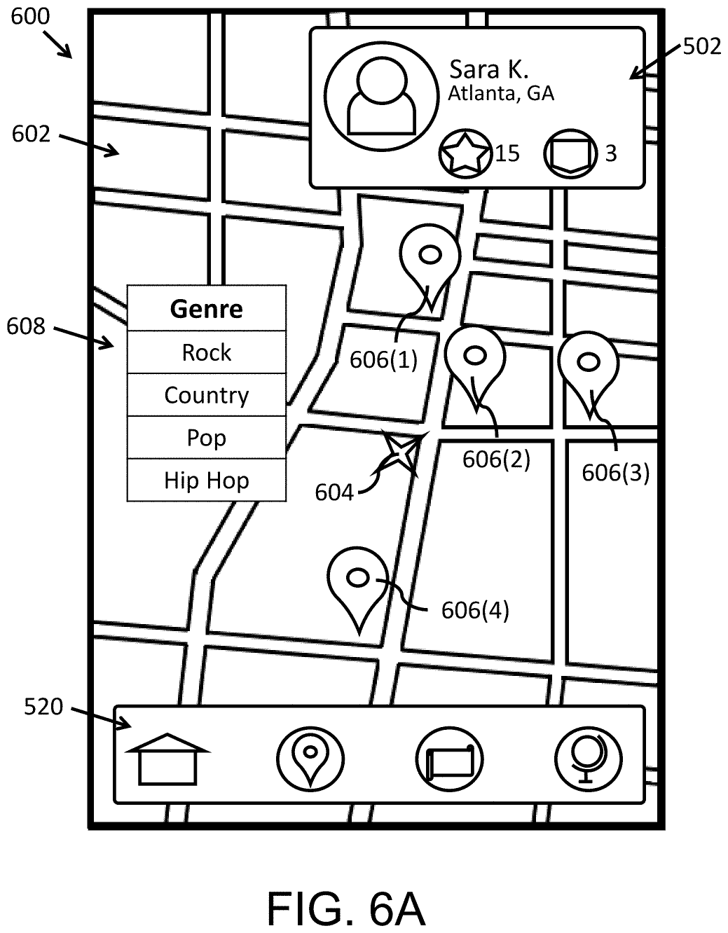

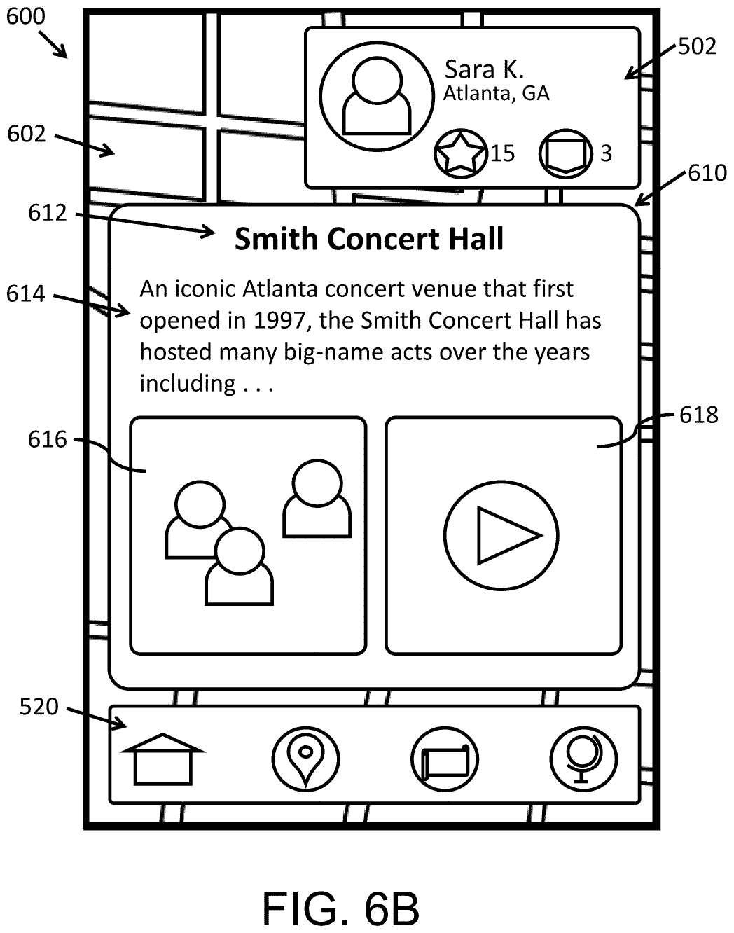

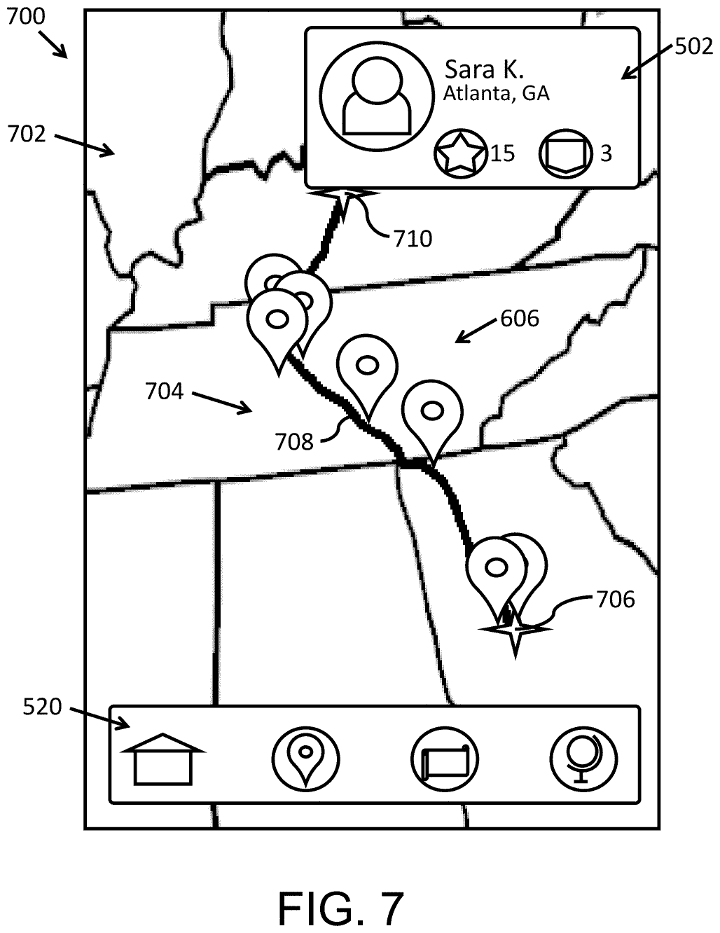

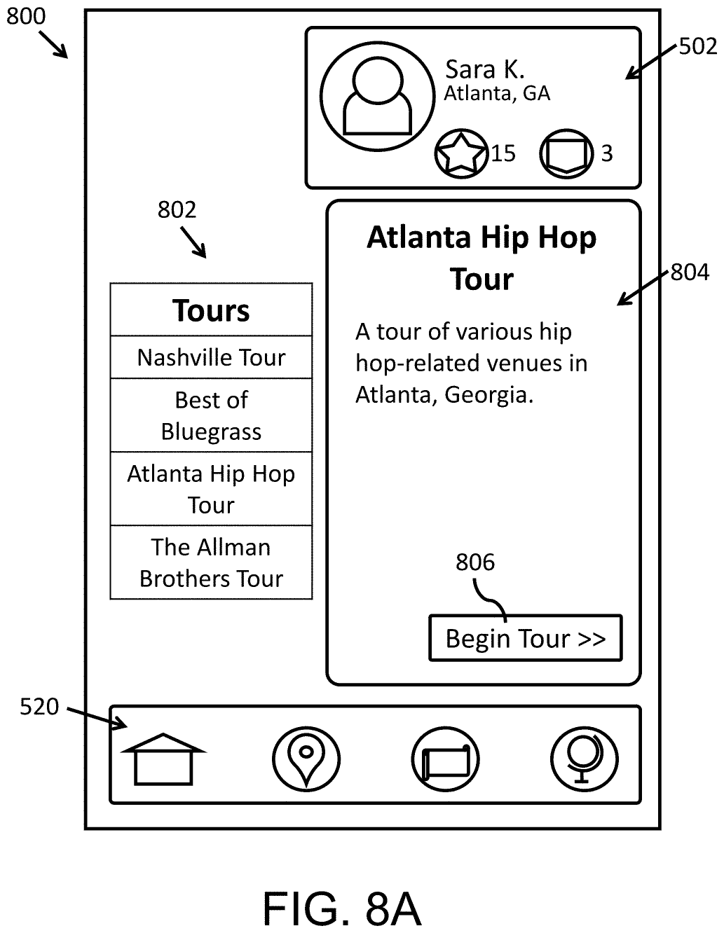

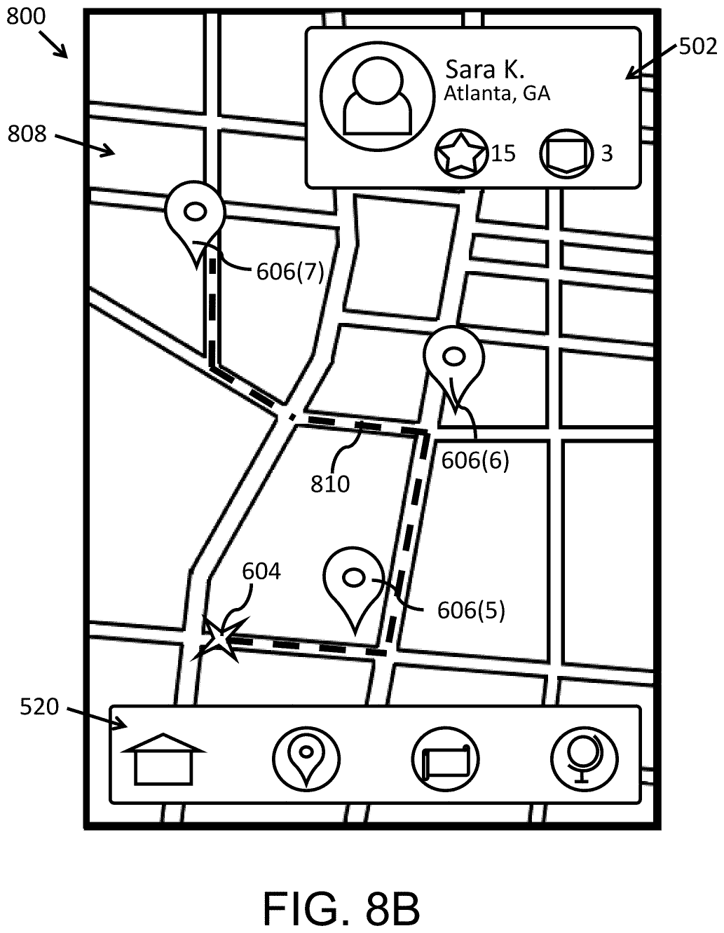

The user interface 500 may include a “POI Near Me” button 510. In response to the user interacting with the “POI Near Me” button 510, the software application 208 may display the user interface 600 of the FIG. 6A, discussed below. The user interface 500 may include a “Road Trip” button 512. In response to the user interacting with the “Road Trip” button 512, the software application 208 may display the user interface 700 of the FIG. 7, discussed below. The user interface 500 may include a “Tours” button 514. In response to the user interacting with the “Tours” button 514, the software application 208 may display the user interface 800 of the FIG. 8A, discussed below. The user interface 500 may include a “Notes and Updates” button 516. In response to the user interacting with the “Notes and Updates” button 516, the user interface 500 may display one or more notes or updates about the software application 208.

The user interface 500 may include a “Newly Added” button 518. The “Newly Added” button 518 may display, on the button 518, one or more images of newly added features to the software application 208. The button may rotate through the images while the user interface 500 is displayed. A newly added feature may include a POI that was recently added to the tour data 310, a newly added tour that was recently added to the tour data 310, or other features. In response to the user interacting with the “Newly Added” button 518, the software application 208 may display further information about the newly added feature displayed on the button 518, which may include the software application 208 displaying a new screen or user interface.

The user interface 500 may include a navigation bar 520. The navigation bar 520 may include one or more buttons that, in response to the user interacting with a button of the navigation bar 520, the software application 208 may take the user to a corresponding user interface. For example, in response to the user interacting with the “Home” button, the software application 208 may display the user interface 500. In response to the user interacting with the “POI Near Me” button, the software application 208 may display the user interface 600 of the FIG. 6A. In response to the user interacting with the “Road Trip” button, the software application 208 may display the user interface 700 of the FIG. 7. In response to the user interacting with the “Tours” button, the software application 208 may display the user interface 800 of FIG. 8A.

FIG. 6A depicts one embodiment of a user interface 600. The user interface 600 may include a user interface of the software application 208. The software application 208 may display the user interface 600 in response to the user interacting with the “POI Near Me” button 510 of the user interface 500 or the “POI Near Me” button of the navigation bar 520. The user interface 600 may include a “POI Near Me” screen of the software application 208. The user interface 600 may include the user profile area 502 or the navigation bar 520.

In some embodiments, the user interface 600 may include a map 602. The map 602 may include a map provided by a map software service integrated with the software application 208 (e.g., Google Maps, Apple Maps, Bing Maps, etc.). In one embodiment, the map 602 may display streets, landmarks, or other geographic information. The user interface 600 may include a current location 604 of the user device 102. The user interface 600 may obtain the current location 604 via the location sensor 210 of the user device 102. The user interface 600 may include one or more POI markers 606(1)-(n). A POI marker 606 may include a marker overlaid on the map 602. A POI marker 606 may correspond to a POI data object of the tour data 310. The user interface 600 may display the POI marker 606 on a location on the map 602 corresponding to the POI.

In some embodiments, the user interface 600 may include one or more filter selection areas 608. A filter selection area 608 may include one or more components that may allow the user of the user device 102 to filter one or more POI markers 606 from being displayed by the user interface 600. For example, as depicted in FIG. 6A, the filter selection area 608 may include a drop-down box. The drop-down box may include one or more options that the user can select. In response to the user selecting an option, the user interface 600 may filter one or more POI markers 606 such that the user interface 600 does not display the filtered POI markers 606. The filter selection area 608 may include options based on a distance (e.g., only showing POI markers 606 whose corresponding POI data object's location is within a predetermined distance from the current location 604 of the user device 102), based on a tag (e.g., only showing POI markers 606 whose corresponding POI data object includes a certain tag), or based on other criteria. In response to the user selecting multiple options in the filter selection area 608, the user interface 600 may display POI markers 606 that correspond to POI data objects whose data confirms to all of the criteria, at least one of the criteria, or some other configuration.

As an example, as depicted in FIG. 6A, the filter selection area 608 includes a drop-down box that includes one or more options related to musical genres. In response to the user selecting the “Rock” option in the filter selection area 608, the user interface 600 may display only POI markers 606 whose corresponding POI data object include a “Rock” tag. Afterwards, in response to the user selecting the “Country” option in the filter selection area 608, the user interface 600 may display only POI markers 606 whose corresponding POI data object include both a “Rock” tag and a “Country” tag, or may display only POI markers 606 whose corresponding POI data object include at least one of the “Rock” tag or the “Country” tag (but not necessarily both).

In one embodiment, in response to the user of the user device 102 interacting with a POI marker 606 displayed on the user interface 600 (e.g., by taping the POI marker 606 on the touchscreen, clicking on the POI marker 606 with a mouse, etc.), the user interface 600 may display content related to the corresponding POI data object.

FIG. 6B depicts one example embodiment of content displayed on the user interface 600 in response to the user interacting with a POI marker 606. The user interface 600 may include a POI box 610. The POI box 610 may overlay the map 602 or other area of the user interface 600. The POI box 610 may include information retrieved from the POI data object that corresponds to the selected POI marker 606. The POI box 610 may include the name 612 of the POI data object, the description 614 of the POI data object, content included in the POI data object (e.g., as depicted in FIG. 6B, an image 616 and a video 618). In response to the user interacting with the content in the POI box 610 (e.g., tapping on or clicking the image 616 or video 618), the content may enlarge so the user may view the content better, play (in the case of a video), initiate a VR or AR sequence, etc.

FIG. 7 depicts one embodiment of a user interface 700. The user interface 700 may include a user interface of the software application 208. The software application 208 may display the user interface 700 in response to the user interacting with the “Road Trip” button 512 of the user interface 500 or the “Road Trip” button of the navigation bar 520. The user interface 700 may include a “Road Trip” screen of the software application 208. The user interface 700 may include the user profile area 502 or the navigation bar 520.

FIG. 7 may include a map 702. The map 702 may be similar to the map 602 of FIG. 6A and FIG. 6B. The user interface may include a road trip 704. The road trip 704 may include a starting location 706, a route 708, and an ending location 710. The user may select the start location 706 or ending location 710 by selecting the location(s) on the map 702, typing the location(s) into a text box (not shown) of the user interface 700, or by some other manner. The software application 208 or a map service integrated with the software application 208 may calculate the route 708 between the starting location 706 and the ending location 710. The user may adjust the route 708. The user interface 700 may display a time to traverse the route 708 by various modes of transportation (e.g., walking, biking, public transportation, car, etc.).

In some embodiments, the user interface 700 may include one or more POI markers 606. The POI markers 606 may be similar to the POI markers 606 of FIG. 6A and FIG. 6B. In some embodiments, the user interface 700 may only display POI markers 606 corresponding to POI data objects whose location data is within a predetermined threshold of the road trip 704. In some embodiments, the user interface 700 may include one or more filter selection areas that may filter out one or more POI markers 606 from the user interface 700, similar to the filter selection area 608 of the FIG. 6A.

FIG. 8A depicts one embodiment of a user interface 800. The user interface 800 may include a user interface of the software application 208. The software application 208 may display the user interface 800 in response to the user interacting with the “Tours” button 514 of the user interface 500 or the “Tours” button of the navigation bar 520. The user interface 800 may include a “Tours” screen of the software application 208. The user interface 800 may include the user profile area 502 or the navigation bar 520.

In some embodiments, the user interface 800 may include a tour selection area 802. The tour selection area 802 may include one or more user interface components that may allow the user of the user device 102 to select a tour. For example, as depicted in FIG. 8A, the tour selection area 802 may include a drop-down box with a list of one or more tours. In response to selecting a tour from the tour selection area 802, the user interface 800 may display a tour box 804. The tour box 804 may include the name of the tour, a description of the tour, or other information regarding the tour. In some embodiments, a tour may correspond to a tour data object of the tour data 310. Some of the components of the tour data object may provide the information (such as the name or description) of the tour box 804. The tour box 804 may include a “Begin Tour” button 806. In response to the user interacting with the “Begin Tour” button 806, the user interface 800 may display tour information.

FIG. 8B depicts one embodiment of a tour map screen of the user interface 800. The user interface 800 may include display the tour map screen in response to a user selecting the “Begin Tour” button 806. The user interface 800 may include a map 808. The map 808 may be similar to the map 602 of FIG. 6A or the map 702 of the FIG. 7. The map 808 may include the user device's 102 current location 604. The current location 604 may be determined by the location sensor 210 of the user device 102. The user interface 800 may include one or more POI markers 606(5)-(7). The POI markers 606(5)-(7) may include one or more POI markers 606 whose corresponding POI data objects may belong to the tour data object that corresponds to the tour the user of the user device 102 has initiated by interacting with the “Begin Tour” button 806. The user interface 800 may include a tour route 810. The tour route 810 may include a route connecting the one or more POI markers 606(5)-(7) of the tour.

In one embodiment, the user of the user device 102 may navigate the tour route 810. While navigating the tour route 810, the current location 604 may continuously update on the user interface 800. The user interface 800 continuously updating the current location 604 may include the current location 604 indicating the user device 102 location substantially in real time.

In one embodiment, the software application 208 may determine that the user device 102 has crossed a geo-fence. This may occur while the software application 208 is displaying the user interface 600 (“POI Near Me”), the user interface 700 (“Road Trip”), the user interface 800 (“Tour”), or while the software application 208 is on some other screen. The software application 208 may obtain the current location 604 of the user device 102 from the location sensor 210 of the user device 102. The software application 208 may send the current location 604 to the server 108, the tour module 304 may retrieve POI data object location data from the tour data 310, and the tour module 304 may calculate if the current location 604 of the user device 102 indicates that the user device 102 has crossed the geo-fence based on the location data of a POI data object. In response, the tour module 304 may send data to the software application 208 indicating the crossing of the geo-fence. The tour module 304 may send content associated with the corresponding POI data object to the software application 208 so that the software application 208 can display the content (e.g., in the POI box 610 of the FIG. 6B). Additionally or alternatively, in some embodiments, the software application 208 may store the location data of one or more POI data objects. The software application 208 may calculate if the current location 604 of the user device 102 indicates that the user device 102 has crossed the geo-fence based on the location data of a POI data object. In response, the software application 208 may display content associated with the corresponding POI data object on the user device 102.

In some embodiments, the content the software application 208 may display to the user on the user device 102 in response to the user device 102 crossing the geo-fence may be different than content displayed to the user in response to tapping on a POI marker 606. This may result in exclusive content that the user can only view if the user crosses the geo-fence, encouraging the user to physically visit a POI.

In some embodiments, the user of the user device 102 may use the software application 208 to create and save a user-made tour. The user-made tour may include one or more POI data objects. The user may select one or more POI markers 606 to select the one or more corresponding POI data objects as the POI data objects of the user-made tour. The user may select a route (such as the route 708 of the FIG. 7) as the route 810 of the user-made tour. The software application 208 or the tour module 304 may save the user-made tour as a tour data object. In some embodiments, the user-made tour data object may be available only to the user that created the tour data object. In other embodiments, the user-made tour data object may be available to one or more other users of the system 100. The user who created the user-made tour data object may customize whether the user-made tour data object is available for use by other users. In some embodiments, the tour module 304 may provide suggested POI data objects to the user of the user device 102. The suggested POI data objects may be based off of past POI locations the user has visited, a music playlist from a music software application integrated with the software application 208, or based on some other data source.

In some embodiments, the user interface 500, 600, 700, or 800 may include an advertisement, a coupon, a merchant incentive, or other paid content. The paid content may include paid content customized to the user of the software application 208 based on the user's visited POI locations, a music playlist from a music software application integrated with the software application 208, based on a profile generated by an advertisement network service (which may include an external service 104), or based on some other data source.

In some embodiments, a user of the user device 102 may add user-generated content to a POI data object. The user-generated content may become part of the content included in the POI data object. As an example, the user of the user device 102 may visit a POI. While at the POI, the user may user the camera of the user device 102 to take pictures or record video. The user may provide the pictures or video to the software application 208, and the software application 208 may send the content to the tour module 304. The tour module 304 may store the content in the tour data 310 and associate the content with the corresponding POI data object. This new content may be available for viewing by one or more other users of the system 100.

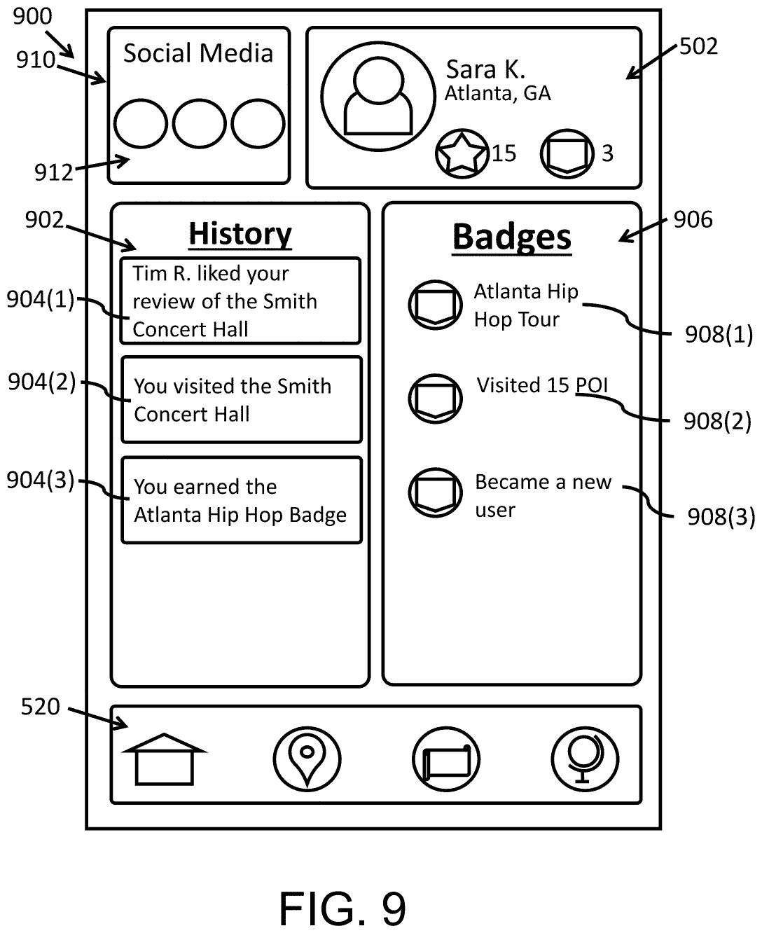

FIG. 9 depicts one embodiment of a user interface 900. The user interface 900 may include a user interface of the software application 208. The software application 208 may display the user interface 900 in response to the user interacting with the user profile area 502. The user interface 900 may include a “User Profile” screen of the software application 208. The user interface 900 may include the user profile area 502 or the navigation bar 520. The user interface 900 may display certain information about the user profile of the user of the software application 208.

In one embodiment, the user interface 900 may include a history area 902. The history area 902 may include one or more events 904. An event 904 may include an action that the user performed regarding the system 100. An event 904 may include the user visiting a POI. For example, the event 904(2) depicts one embodiment of an event 904 indicating that the user visited the POI “Smith Concert Hall.” An event 904 may include the user earning a badge. For example, the event 904(3) depicts one embodiment of an event 904 indicating that the user earned the “Atlanta Hip Hop Badge.” An event 904 may include another user interacting with content generated by the user of the user device 102. Another user interacting with the content generated by the user may include the other user leaving a review on the content, the other user rating the content, the other user sharing the content on a social media platform, or other interaction actions. For example, the event 904(1) depicts one embodiment of an event 904 indicating that another user “liked” the user's review (which may include user-generated text content) of the Smith Concert Hall. The history area 902 may include at least a portion of the user's past events 904. The user may interact with an event 904 so that the user interface 900 can display further information about the event 904. In some embodiments, the user may be able to filter events 904 in the history area 902 by event type (e.g., badges earned, POIs visited, interactions with other users).

In one embodiment, the user interface 900 may include a badges area 906. The badges area 906 may display one or more badges 908 the user has earned. A user may earn a badge 908 in response to the user completing a predetermined action. In some embodiments, a user may earn a badge 908 in response to visiting a predetermined number of POIs. For example, the badge 908(2) may indicate that the user has visited 15 POIs. A user may earn a badge 908 in response to completing a tour. Completing a tour may include the user visiting one or more POI whose corresponding POI data objects are included in a tour data object. As an example, the badge 908(1) may indicate that the user has completed the “Atlanta Hip Hop Tour.” In one embodiment, a user may earn a badge 908 in response to some other user action such as becoming a new user (e.g., as indicated by the badge 908(3)), visiting a predetermined POI, visiting a predetermined number of POI whose corresponding data objects include a predetermined tag (e.g., visiting 10 POI with a certain musical artist's tag), or in response to some other user action.

In one embodiment, the user interface 900 may include a social media area 910. The social media area 910 may include one or more buttons 912, each of which may correspond to a social media platform. In response to the user interacting with a button 912 of the social media area 910, the user may perform an action on the corresponding social media platform. The user performing an action may include the user positing an even 904 or a badge 908 to the social media platform.

In one embodiment, the software application 208 may include an augmented reality (AR) user interface. The software application 208 may display the AR user interface in response to the user device 102 crossing a geo-fence, a camera of the user device 102 capturing an image and the software application 208 or the touring module 304 detecting a predetermined piece of data within the image, or in response to some other triggering event.

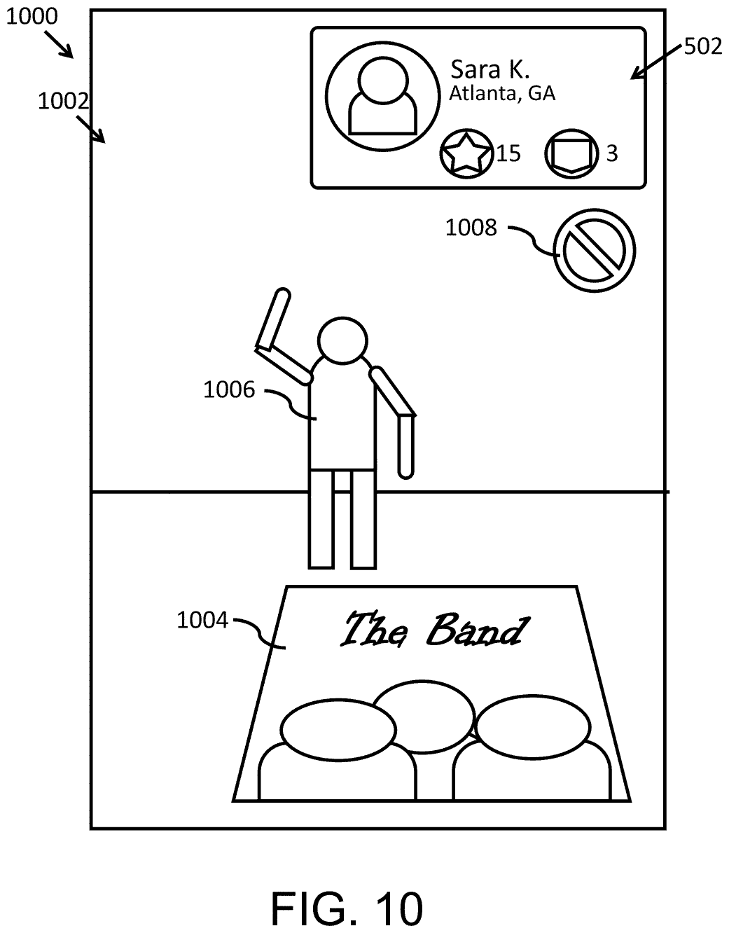

FIG. 10 depicts one embodiment of user interface 1000. The user interface 1000 may include an AR user interface. The user interface 1000 may include the user profile area 502. The user interface 1000 may include an image capture area 1002. The image capture area 1002 may include an image or a video captured by a camera of the user device 102. The user moving the user device 102 around may result in the camera capturing a different image or video and the image capture area 1002 displaying the captured image or video. In some embodiments, the image capture area 1002 may include a real-world object 1004. For example, as depicted in FIG. 10, the image capture area 1002 may include a musical album cover 1004. The software application 208 may send the captured image, which may include the image of the real-world object 1004 to the server 108. The server 108 may perform data analytics on the received image, or an external service 104 may perform the data analytics on the received image. The data analytics may include classifying or identifying the image or at least a portion of the image (e.g., the real-world object 1004). In response to at least a portion of the received image including a predetermined image, the software application 208 may display an AR component of the user interface 1000.

In some embodiments, the user interface 1000 may include an AR component 1006. The AR component 1006 may include virtual content displayed on the user interface 1000. For example, as depicted in FIG. 10, the AR component 1006 may include a three-dimensional model of a person. The person may include a person in a musical group, and the real-world object 1004 may include a musical album by the same musical group. The AR component 1006 may be animated and may move around in the user interface 1000. In response to the user interacting with the AR component, the user interface 1000 may display or reproduce content. For example, in response to the user tapping the AR component 1006, audio may play, the user interface 1000 may display an image, video, or text box, or may perform other functionality. In one embodiment, the user interface 1000 may include an “Exit” button 1008. In response to the user interacting with the “Exit” button 1008, the user interface 1000 may cease to capture the image or video in the image capture area 1002. The software application 208 may return to a different user interface of the software application 208.

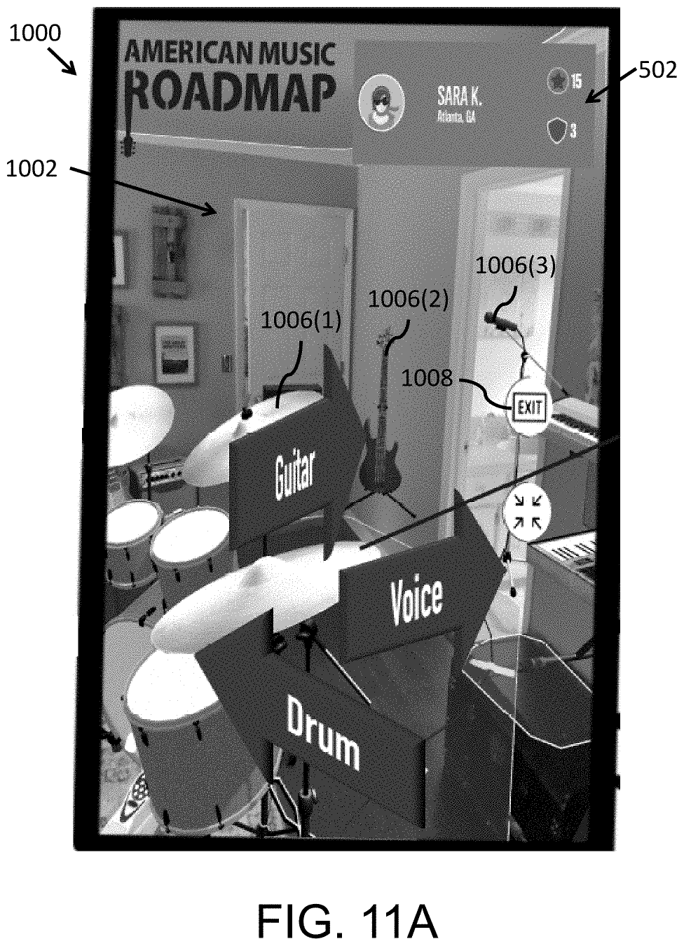

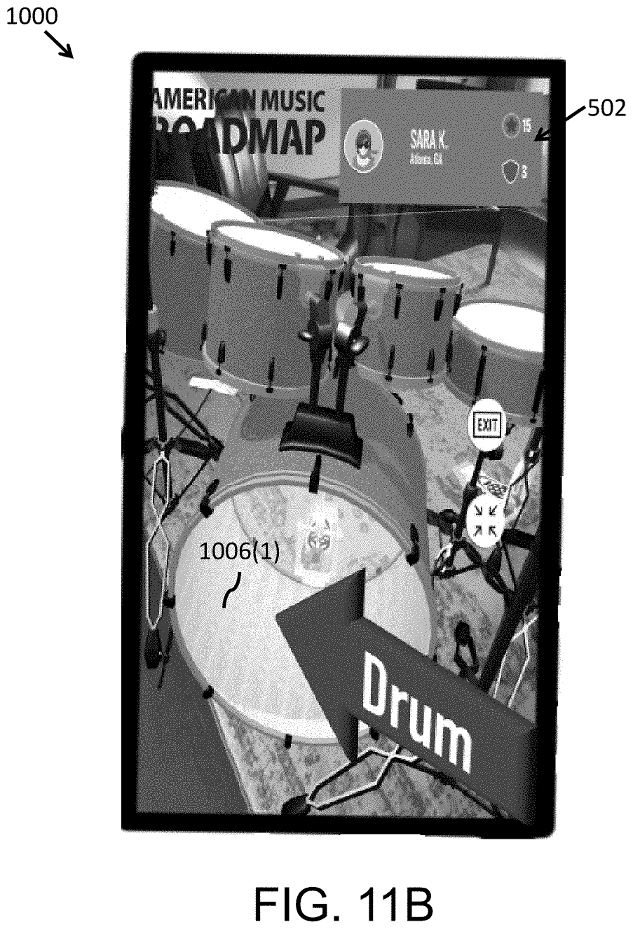

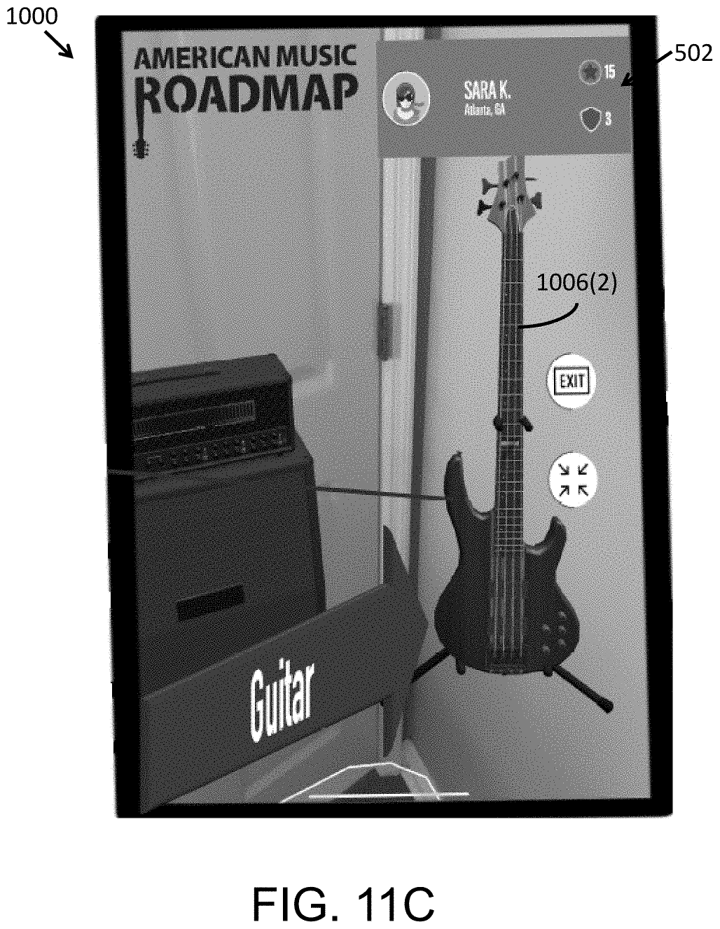

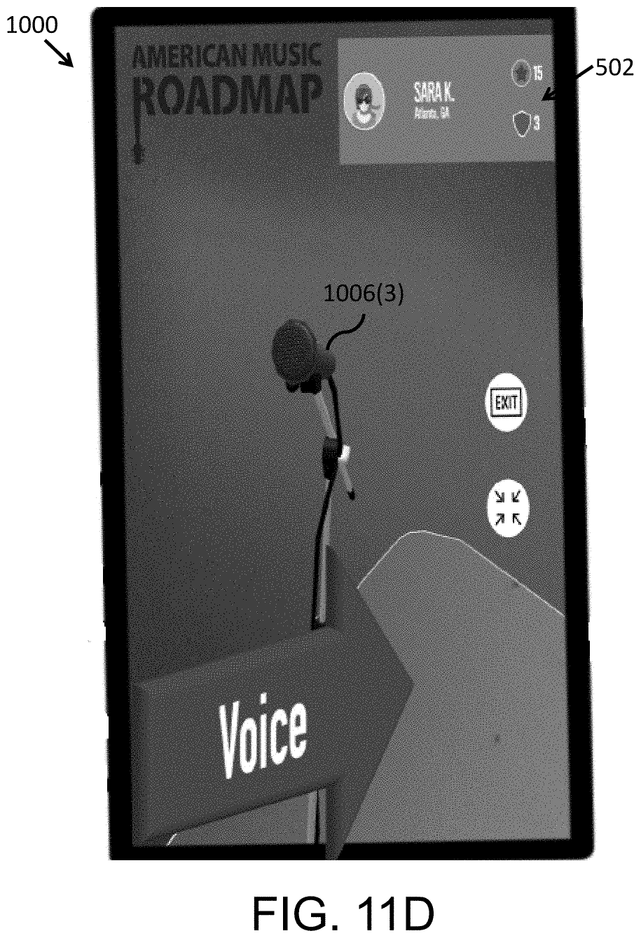

FIG. 11A depicts one embodiment of the user interface 1000. In one embodiment, the user interface 1000 may display an AR spatial audio experience. A spatial audio experience may include the image capture area 1002. The image capture area 1002 may include an image or video captured by the camera of the user device 102. The image capture area 1002 may serve as a background over which the user interface 1000 may overlay one or more AR components 1006. The spatial audio experience may include one or more AR components 1006(1)-(3) displayed on the user interface 1000. An AR component 1006 of the spatial audio experience may include a musical instrument, a vocalist, a speaker, or some other audio source. Each of the AR components 1006(1)-(3) may include a corresponding audio content. The audio content may include musical content, vocal content, or other audio content. As the user device 102 changes distances from AR components 1006(1)-(3), the audio content corresponding to the AR components 1006(1)-(3) may change volume based on a location of the user device 102. This may include the volume of one piece of audio content becoming louder in response to the user device 102 moving closer to the corresponding AR content 1006, and the volume of another piece of audio content becoming softer in response to the user device 102 moving further away from the corresponding AR content 1006. In some embodiments, in response to the user device 102 being within a certain threshold distance of a certain AR content 1006, the corresponding audio content may play and one or more other audio content corresponding to other AR content may be muted.

As an example of a spatial audio experience depicted in FIG. 11A, the pieces of AR content 1006 may include a virtual drum set 1006(1), a virtual guitar 1006(2), and a virtual vocalist 1006(3). The user interface 1000 may display each of the virtual instruments as an AR component 1006. The user interface 1000 may display each virtual instrument at a certain location. Each virtual instrument may include a corresponding audio track, and the audio track of the different instruments may be synchronized. As depicted in FIG. 11B, in response to the user device 102 moving (as determined by a location sensor 210 or other movement sensor of the user device 102) toward the virtual drum set 1006(1), the audio track corresponding to the drum set may play louder, and the other audio tracks may play softer. As depicted in FIG. 11C, in response to the user device 102 moving toward the virtual guitar 1006(2), the audio track corresponding to the guitar may play louder, and the other audio tracks may play softer. As depicted in FIG. 11D, in response to the user device 102 moving toward the virtual microphone 1006(3), the audio track corresponding to the vocalist may play louder, and the other audio tracks may play softer. The user may move the user device 102 to different locations to hear different volumes of the different audio tracks until, for example, the user finds a location where the volume balances are most enjoyable to the user.

In some embodiments, the software application 208 may determine the proximity of the user device 102 to a piece of AR content 1006 in the spatial audio experience using location data obtained from the location sensor 210 of the user device 102. The software application 208 may use a geo-fence to determine whether the user device 102 is within sufficient proximity of the AR content 1006. The software application 208 may use geolocation data, motion data, orientation data, or other data from the location sensor 210 and may calculate an updated position of the user device 102 relative to the location of the AR content 1006. In other embodiments, the software application 208 or the tour module 304 may determine the location of the user device 102 relative to one or more pieces of AR content 1006 using some other method. In some embodiments, the software application 208 may calculate a position of the user device 102 from a virtual point of reference. The virtual point of reference may include a center of the spatial audio experience. The software application 208 may play one or more audio content corresponding to the AR content 1006 of the spatial audio experience relative to the reference point. This may include adjusting the volume over a three-dimensional distance or reverberation over AR content 1006 or other objects in the spatial audio experience. Additionally or alternative, the software application 208 may play audio content according to a priority or audio mixing of the different audio content.

In some embodiments, the software application 208 may collect data regarding the user of the user device 102. The data collection may include the software application 208 collecting data regarding the use of the software application 208 by the user. The software application 208 may collect the user device 102 location (as determined by the location sensor 210) at various times. The data software application 208 collecting the location data may allow the server 108 to calculate how much time a user spent at a certain location, such as a location corresponding to a POI marker 606 or a POI data object. The data collection may include the software application 208 collecting data regarding which content associated with a POI data object the user viewed or how much time the user spent viewing the content. The content may include the AR content or the spatial audio experience content.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable media.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present disclosure of a new and useful systems and methods for delivering content to a user based on geolocation, it is not intended that such references be construed as limitations upon the scope of this disclosure.

What is claimed is:

1. A system for delivering content to a user based on geolocation, comprising:
a user device, including
a location sensor, and
a first non-transitory computer-readable storage medium with a software application stored thereon; and
a server, including
a second non-transitory computer-readable storage medium with executable instructions stored thereon, wherein the executable instructions, when executed by a processor, are configured to execute a tour module, and
a data storage, including user data and tour data stored thereon,
wherein
the tour data includes a point of interest (POI) data object, including location data and content data,
the software application of the user device is configured to
obtain a location of the user device from the location sensor, and
send the location to the tour module,
the tour module is configured to
determine, from the location of the user device, that the user device is within a geo-fence of the POI data object and,
in response to determining that the user device is within the geo-fence, send the content data to the software application, and
the software application is configured to display the content data on the user device.

2. The system of claim 1, wherein the user device comprises at least one of:
a smart phone;
a smart watch; or
a tablet computer.

3. The system of claim 1, wherein the location sensor comprises at least one of:
a geolocation sensor;
a global positioning system (GPS) sensor; or
a cellular sensor.

4. The system of claim 1, wherein the location sensor comprises at least one of:
an accelerometer;
a gyroscope; or
a motion sensor.

5. The system of claim 1, wherein the POI data object corresponds to a real-world location.

6. The system of claim 5, wherein the location data of the POI data object includes at least one of:
a latitude of the real-world location;
a longitude of the real-world location;
GPS coordinates of the real world location; or
an altitude of the real-world location.

7. The system of claim 5, wherein the content data of the POI data object includes:
image data associated with the real-world location;
video data associated with the real-world location;
audio data associated with the real-world location;
text data associated with the real-world location;
augmented reality (AR) data associated with the real-world location; or
virtual reality (VR) data associated with the real-world location.

8. A method of delivering content to a user based on geolocation, comprising:
at a server in data communication with a user device:
storing a point of interest (POI) data object, wherein
the POI data object corresponds to a real-world location, and
the POI data object includes location data and content data associated with the real-world location;
receiving, from the user device, a location of the user device;
determining, based on the location of the user device and the location data of the POI object, that the user device is within a geo-fence of the POI data object,
in response to determining that the user device is within the geo-fence, sending the content data to the user device,
wherein the content data is configured to be displayable via the user device.

9. The method of claim 8:
wherein storing the POI data object comprises storing a plurality of POI data objects; and
further comprising, at the server:
receiving road trip data from the user device, including
a start location,
a route, and
an end location,
determine, based on the location data of a POI data object, whether the POI data object of the plurality of POI data objects is within a predetermined threshold distance from the route, and
in response to the POI data object of the plurality of POI data objects being within the predetermined threshold distance, sending the POI data object to the user device.

10. The method of claim 8:
wherein storing the POI data object comprises storing a plurality of POI data objects; and
further comprising, at the server:
storing a tour data object, comprising
text data including a description of a tour, and
at least a portion of the plurality of POI data objects.

11. The method of claim 10, further comprising:
at the server:
receiving the tour data object from the user device, wherein the tour data object comprises a user-generated tour data object.

12. The method of claim 8:
wherein the content data of the POI data object includes first content data and second content data;
further comprising, in response to determining that the user device is not within the geo-fence, sending the first content data to the user device; and
wherein, in response to determining that the user device is within the geo-fence, sending the content data to the software application includes sending the second content data to the user device.

13. The method of claim 8, further comprising:
at the server:
receiving, from the user device, user-generated content;
storing the user-generated content on the server; and
including the user-generated content in the content data of the POI data object.

14. The method of claim 13, wherein the user-generated content includes content generated at the real-world location corresponding to the POI data object.

15. The method of claim 8, wherein:
the POI data object further includes tag data; and
the tag data includes at least one of
data indicating a genre of music,
data indicating a musical artist, or
data indicating a concert.

16. The method of claim 8, further comprising:
at the server:
receiving, from the user device, image data;
identifying the image data via data analytics;
determining whether the image data corresponds to a predetermined image; and
in response to determining the image data corresponds to the predetermined image, sending augmented reality (AR) data to the user device.

17. The method of claim 16, wherein the AR data includes a three-dimensional model of a person.

18. A method of presenting a spatial audio experience on a user device, comprising:
providing a plurality of augmented reality (AR) musical instruments, wherein each AR musical instrument includes
a corresponding audio track, and
a location within the spatial audio experience;
determining a location of the user device within the spatial audio experience;
playing the audio track of each AR musical instrument at a volume based on a distance between the user device and the location of the corresponding AR musical instrument;
determining that the location of the user device has changed; and
adjusting the volume of each audio track based on the new location of the user device.

19. The method of claim 18, wherein adjusting the volume of an audio track of the audio tracks of the plurality of AR musical instruments includes at least one of:
decreasing the volume in response to the location of the user device moving away from the location within the spatial audio experience of the AR musical instrument; or
increasing the volume in response to the location of the user device moving toward the location within the spatial audio experience of the AR musical instrument.

20. The method of claim 18, wherein an AR musical instrument of the plurality of AR musical instruments comprises at least one of:
a guitar;
a drum set; or
a vocalist.
